(19) United States
(12) Patent Application Publication
(10) Pub. No.: US 2009/0167040 A1
(43) Pub. Date: Jul. 2, 2009

(54) Chopsticks with a magnetic open device

(76) Inventors: Kun Yuan Tong, Suwanee, GA (US); David Tong, Atlanta, GA (US)

Correspondence Address: Kun Yuan Tong, 2842 Lowe Court, Suwanee, GA, 30024, US

(21) Appl. No.: 12/006,001

(22) Filed: Dec. 29, 2007

(51) Int. Cl. B25B 9/00

(52) U.S. Cl. 294/99.2

(57) ABSTRACT

Chopsticks with a magnetic open device consists of a pair of chopsticks that each chopstick has installed a magnetic disc. The polarity of the magnetic discs of chopsticks is properly arranged to let chopsticks attract each other and to form a about 30 degrees of angle to facilitate grasping foods.

### THE BACKGROUND OF THE INVENTION

It is not easy for people other than the oriental people to use chopsticks. If chopsticks have a magnetic open device then any person can use it easily.

### THE BRIEF SUMMARY OF THE INVENTION

The present invented chopsticks with a magnetic open device have magnetic discs installed on chopsticks. The polarity of the magnetic disc of a pair of chopsticks is properly arranged to make chopsticks open at a certain angle to facilitate grasping foods.

### THE DETAILED DESCRIPTION OF THE DRAWINGS

FIG. 1 is a perspective view of a pair of chopsticks with a magnetic open device having a about 30 degrees of opening angle.

FIG. 2 is a perspective view of one chopstick of a pair of chopsticks with a magnetic open device that has installed a magnetic disc A.

FIG. 3 is a perspective view of another chopstick of a pair of chopsticks with a open device that has installed a magnetic disc B.

FIG. 4 is a perspective view of a removable magnetic disc A.

FIG. 5 is a perspective view of a removable magnetic disc B.

### THE DETAILED DESCRIPTION OF THE INVENTION

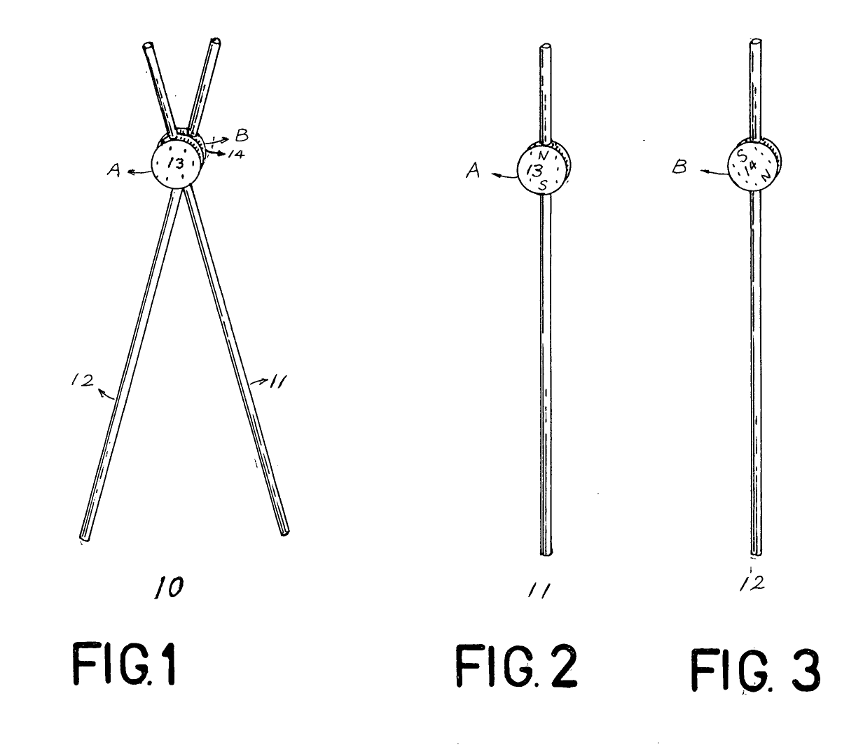

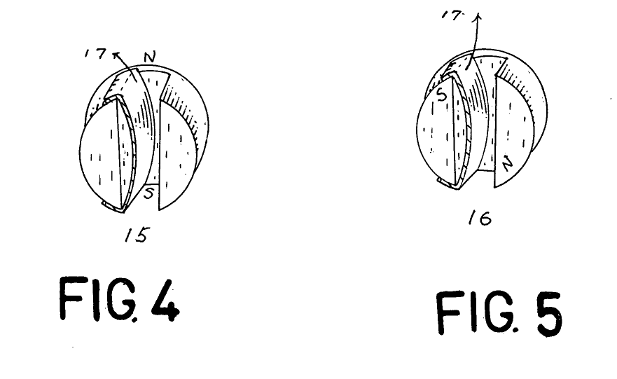

Referring now in detail to the drawing, numeral 10 of FIG. 1 is a pair of chopsticks with a magnetic open device opening in about 30 degrees of angle. Numeral 11 of FIGS. 1 and 2 is one chopstick of a pair of chopsticks 10 and has installed a magnetic disc A 13. Magnetic disc A 13 of FIGS. 1 and 2 has positive polarity (N) at upper end and negative polarity (S) at lower end. The direction of the polarity of magnetic disc A 13 is vertical and same to that of chopstick 11. Numeral 12 of FIGS. 1 and 3 is another chopstick of a pair of chopsticks 10 of FIG. 1 and has installed a magnetic disc B 14. Magnetic disc B 14 has negative polarity (S) at upper end and positive polarity (N) at lower end. The direction of the polarity of magnetic disc B 14 forms a about 30 degrees of angle to that of chopstick 12. Therefore when chopstick 11 of FIGS. 1 and 2 and chopstick 12 of FIGS. 1 and 3 stick together by magnetic discs A and B they form a about 30 degrees of angle because of the polarity of magnetic discs A 13 and magnetic disc B 14. Magnetic disc A and Magnetic disc B are of the same disc shape but they can be of different kind of shape such as round shape, star shape, flower shape, square shape, etc. The magnetic disc A 13 and B 14 can be built-in onto chopsticks or can be removable. Numeral 15 of FIG. 4 is a removable magnetic disc A 13. Numeral 16of FIG. 5 is a removable magnetic disc B 14. Numeral 17 of FIGS. 4 and 5 is an arched spring to catch in chopstick.

1. Chopsticks with a magnetic open device comprising a pair of chopsticks that each chopstick has installed a magnetic disc.

2. The said magnetic disc in claim 1 is installed at the upper one third or one fourth portion of each of the said a pair of chopsticks in claim 1.

3. The said magnetic disc in claim 1 and 2 has its polarity properly arranged to let the said a pair of chopsticks in claim 1 open at a certain degree of angle.

4. The said magnetic disc in claims 1, 2 and 3 can be of a variety of shape, such as round shape, star shape, flower shaped, square shape, etc.

5. The said magnetic disc in claims 1, 2, 3 and 4 can be built-in or removable.
